(19) United States
(12) Patent Application Publication
(10) Pub. No.: US 2015/0023410 A1
(43) Pub. Date: Jan. 22, 2015

(54) METHOD FOR SIMULTANEOUSLY CODING QUANTIZED TRANSFORM COEFFICIENTS OF SUBGROUPS OF FRAME

(71) Applicant: ArcSoft Hangzhou Co., Ltd., Hangzhou City (CN)

(72) Inventors: YaGuang Xie, Hangzhou City (CN); Jin Huang, Hangzhou City (CN); JunQing Wan, Hangzhou City (CN)

(21) Appl. No.: 13/942,725

(22) Filed: Jul. 16, 2013

(51) Int. Cl. H04N 19/176; H04N 19/48; H04N 19/124

(52) U.S. Cl. CPC H04N 19/00278; H04N 19/0009; H04N 19/00563
USPC 375/240.03

(57) ABSTRACT

A plurality of context adaptive variable length coding (CAVLC) procedures are simultaneously performed to code quantized transform coefficients of subgroups of a target frame. Each of the subgroups contains a plurality of macroblocks, and the macroblocks of each subgroup are arranged in a same row of macroblocks. Each of the CAVLC procedures is configured to code quantized transform coefficients of a subgroup of the target frame into a coded string. By simultaneously performing the CAVLC procedures, a plurality of coded strings are generated simultaneously. According to the coded strings, encoded data of the target frame is generated.

### BACKGROUND OF THE INVENTION

1. Field of the Invention

The invention is related to a method for coding quantized transform coefficients of frames, and more particularly to a method for simultaneously coding quantized transform coefficients of subgroups of one of frames using context adaptive variable length coding (CAVLC).

2. Description of the Prior Art

Video compression (or video encoding) is an essential technology for applications such as digital television, DVD-Video, mobile TV, videoconferencing and internet video streaming. Video compression is a process of converting digital video into a format suitable for transmission or storage, while typically reducing the number of bits.

H.264 is an industry standard for video compression, the process of converting digital video into a format that takes up less capacity when it is stored or transmitted. An H.264 video encoder carries out prediction, transform and coding processes to produce a compressed H.264 bitstream (i.e. syntax). During the prediction processes, the encoder processes frames of video in units of a macroblock and forms a prediction of the current macroblock based on previously-coded data, either from the current frame using intra prediction or from other frames that have already been coded using inter prediction. H.264/AVC specifies transform and quantization processes that are designed to provide efficient coding of video data, to eliminate mismatch or ‘drift’ between encoders and decoders and to facilitate low complexity implementations. After prediction, transform and quantization, the video signal is represented as a series of quantized transform coefficients together with prediction parameters. These values must be coded into a bitstream that can be efficiently transmitted or stored and can be decoded to reconstruct the video signal. Context adaptive variable length coding (CAVLC) is a specially-designed method of coding transform coefficients in which different sets of variable-length codes are chosen depending on the statistics of recently-coded coefficients, using context adaptation.

During the processes of CAVLC, coefficient blocks containing the quantized transform coefficients are scanned using zigzag or field scan and converted into a plurality of series of variable length codes (VLCs). However, since the coefficient blocks for each frame are successively scanned and converted, the VLCs of the current frame would be generated one by one. Therefore, if every frame has a high resolution, coding the quantized transform coefficients would be time-consuming.

### SUMMARY OF THE INVENTION

According to an exemplary embodiment of the claimed invention, a method for simultaneously coding quantized transform coefficients of subgroups of a target frame by an encoder is provided. The target frame contains M×N macroblocks arranged in M rows and N columns, each of the subgroups contains a plurality of macroblocks of the M×N macroblocks, and the macroblocks of each subgroup are arranged in a corresponding one of the M rows. The method comprises simultaneously performing a plurality of context adaptive variable length coding (CAVLC) procedures of the target frame to generate a plurality of coded strings, and outputting encoded data of the target frame by the encoder according to the coded strings. Each of the CAVLC procedures is configured to code quantized transform coefficients of a subgroup of the target frame into a coded string.

According to another exemplary embodiment of the claimed invention, a method for simultaneously encoding macroblocks of one of frames of a video stream by an encoder is provided. A reference frame associated with the frames of the video stream is in a prior sequence than a target frame of the video stream, and each of the reference frame and the target frame comprises a plurality of groups. Each of the groups contains m×n macroblocks arranged in m rows and n columns, m and n being integers greater than 1. Each of the groups of the target frame comprises a plurality of subgroups, and each of the subgroups contains a plurality of macroblocks arranged in a corresponding one of the m rows of a group. The method comprises: simultaneously performing a plurality of prediction procedures of the groups of the second frame to generate a plurality of series of predictions, transforming the series of predictions into quantized transform coefficients of the subgroups of the target frame, simultaneously performing a plurality of context adaptive variable length coding (CAVLC) procedures of the target frame to generate a plurality of coded strings, and outputting encoded data of the target frame by the encoder according to the coded strings. Each of the prediction procedures is configured to predict macroblocks of a target group of the groups of the second frame and comprises: performing a plurality of macroblock comparison procedures of the target group to generate a plurality of sub-strings of data, and generating one of the series of predictions according to the sub-strings of data. Each macroblock comparison procedure is configured to compare a target macroblock of the m×n macroblocks of the target group with each macroblock of a macroblock set associated with the target macroblock, and the macroblock set comprises a reference macroblock of a reference group of the first frame. Each of the CAVLC procedures is configured to code quantized transform coefficients of a subgroup of the target frame into a coded string.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a video encoder according to an embodiment of the present invention.

FIG. 2 is a schematic diagram of a video source shown in FIG. 1.

FIG. 3 is a schematic diagram of an encoded frame of the video source.

FIG. 4 is a schematic diagram of quantized transform coefficients of the encoded frame of the video source.

FIG. 5 illustrates an overview of coding the quantized transform coefficients.

FIG. 6 illustrates an overview of the structures of a video stream and a bitstream.

FIG. 7 is a schematic diagram of a frame of the video stream shown in FIG. 6.

FIG. 8 is a schematic diagram of sets of quantized transform coefficients transformed from series of predictions shown in FIG. 6.

FIG. 9 illustrates an overview of coding the sets of the quantized transform coefficients.

### DETAILED DESCRIPTION

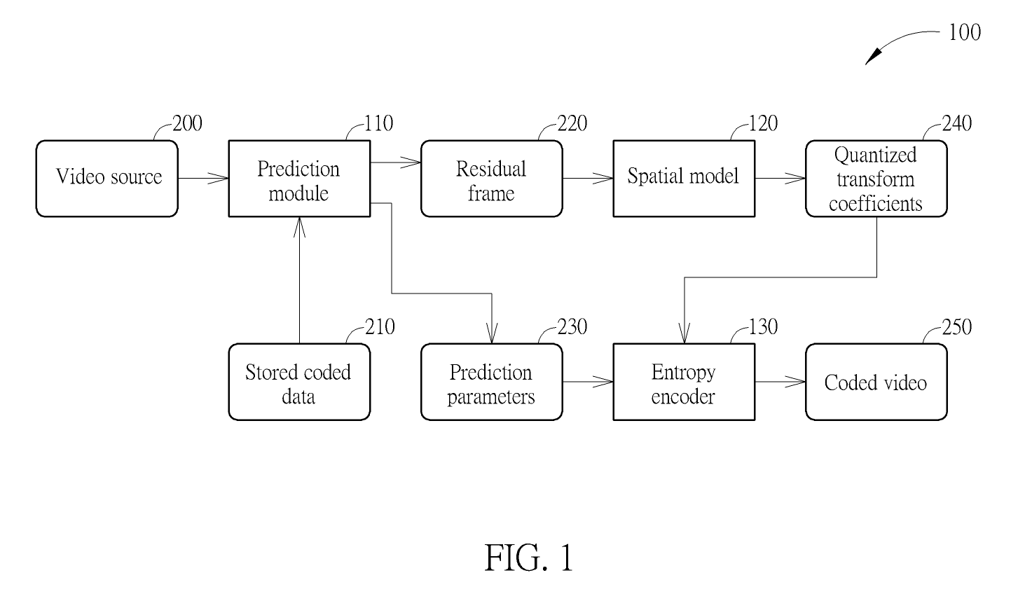

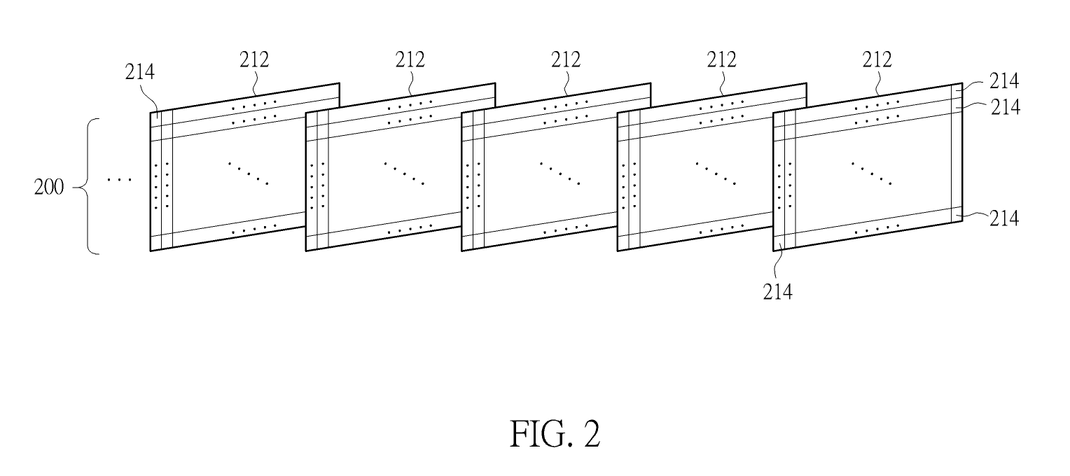

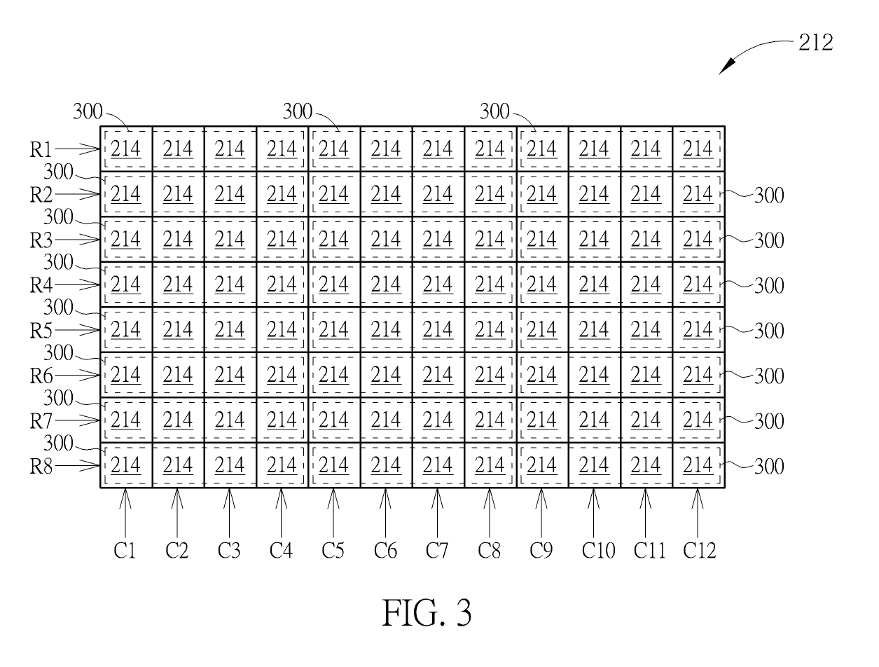

Please refer to FIG. 1. FIG. 1 is a schematic diagram of a video encoder 100 according to an embodiment of the present invention. The video encoder 100 has three main functional units: a prediction model 110, a spatial model 120 and an entropy encoder 130. A video source 200 inputted to the prediction model 110 is an uncompressed “raw” video sequence. As shown in FIG. 2 and FIG. 3, the video source 200 comprises a plurality of frames 212, each of the frames 212 comprises a plurality of subgroups 300, each of the subgroups 300 comprises a plurality of macroblocks 214, and each of the macroblocks 214 typically comprises 16×16 pixels. The macroblocks 214 of each frame 212 are arranged in M rows and N columns, where M and N are integers greater than 1 and could be determined if the resolution of the frame 212 is known. In the embodiment, M=8 and N=12, but the present invention is not limited thereto.

Please refer to FIG. 1 and FIG. 2. The prediction model 110 of the video encoder 100 attempts to reduce redundancy by exploiting the similarities between neighbouring video frames and/or neighbouring image samples of the video source 200, typically by constructing a prediction of the current video frame or block of video data. In H.264/AVC, the prediction is formed from data in the current frame or in one or more previous and/or future frames (i.e. stored coded data 210). It is created by spatial extrapolation from neighbouring image samples, intra prediction, or by compensating for differences between the frames, inter or motion compensated prediction. The prediction model 110 processes the frames 212 of the video source 200 in units of a macroblock 214 and forms a prediction of the current macroblock based on the stored coded data 210, either from the current frame using intra prediction or from other frames that have already been coded using inter prediction. The output of the prediction model 110 is a residual frame 220, created by subtracting the prediction from the actual current frame (i.e. an encoded frame 212 of the video source 200), and a set of prediction parameters 230 indicating the intra prediction type or describing how the motion was compensated. Therefore, the prediction model 110 predicts the encoded frame 212 in units of a macroblock 214 to generate the residual frame 220.

The spatial model 120 processes the residual frame 220 to generate a set of quantized transform coefficients 240 of the encoded frame 212 of the video source 200. The residual frame 220 forms the input to the spatial model 120 which makes use of similarities between local samples in the residual frame 220 to reduce spatial redundancy. In H.264/AVC this is carried out by applying a transform to the residual samples and quantizing the results. The transform converts the samples into another domain in which they are represented by transform coefficients. The transform coefficients are quantized to remove insignificant values, leaving a small number of significant coefficients that provide a more compact representation of the residual frame 220. Accordingly, the spatial model 120 outputs the quantized transform coefficients 240 of the encoded frame 212 to the entropy encoder 130.

The prediction parameters 230 and the quantized transform coefficients 240 are compressed by the entropy encoder 130. The entropy encoder 130 removes statistical redundancy in the data of the prediction parameters 230 and the quantized transform coefficients 240, for example representing commonly occurring vectors and coefficients by short binary codes. The entropy encoder 130 produces a compressed bit stream or file (i.e. coded video 250) that maybe transmitted and/or stored. The compressed coded video 250 may have coded prediction parameters, coded residual coefficients and header information.

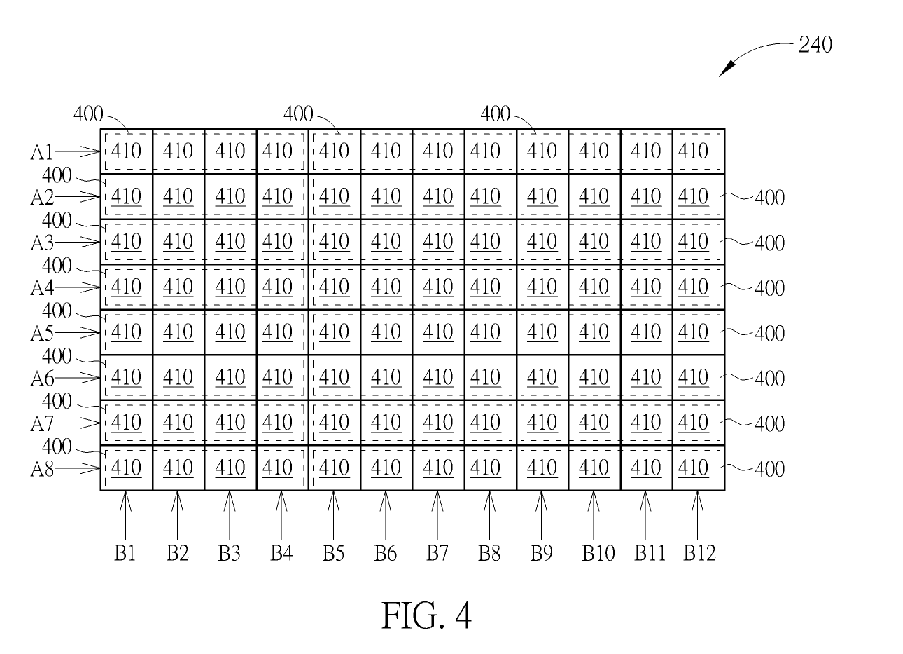

As mentioned previously, the prediction model 110 predicts the encoded frame 212 in units of a macroblock 214 to generate the residual frame 220, and the spatial model 120 processes the residual frame 220 to generate the quantized transform coefficients 240 of the encoded frame 212. Accordingly, the quantized transform coefficients 240 of the encoded frame 212 could be represented based on the arrangement of the macroblocks 214 of the encoded frame 212. Referring to FIG. 3 and FIG. 4, since the macroblocks 214 of the encoded frame 212 are arranged in eight rows R1 to R8 and twelve columns C1 to C12, the quantized transform coefficients 240 of the encoded frame 212 could be represented by a plurality of coefficient blocks 410 arranged in eight rows A1 to A8 and twelve columns B1 to B12. Each of the coefficient blocks 410 is corresponded to a macroblock 214 and arranged at a location related to the macroblock 214. For example, the coefficient block 410 in the first row A1 and the first column B1 is corresponded to the macroblock 214 in the first row R1 and the first column C1, the coefficient block 410 in the first row A1 and the second column B2 is corresponded to the macroblock 214 in the first row R1 and the second column C2, and so on. In addition, each of the coefficient blocks 410 comprises related quantized transform coefficients converted from the corresponded macroblock 214. For instance, the coefficient block 410 in the first row A1 and the first column B1 comprises the quantized transform coefficients converted from the macroblock 214 in the first row R1 and the first column C1, the coefficient block 410 in the first row A1 and the second column B2 comprises the quantized transform coefficients converted from the macroblock 214 in the first row R1 and the second column C2, and so on.

The quantized transform coefficients 240 also could be represented by a plurality of subgroups 400, and each of the subgroups 400 is corresponded to a subgroup 300 of the encoded frame 212 and comprises a plurality of the coefficient blocks 410. In the embodiment, since each of the subgroups 300 comprises four macroblocks 214, each of the subgroups 400 comprises four coefficient blocks 410. However, the present invention is not limited thereto. For example, the number of the macroblocks 214 of a subgroup 300 could be equal to 2, 3, 5, etc.

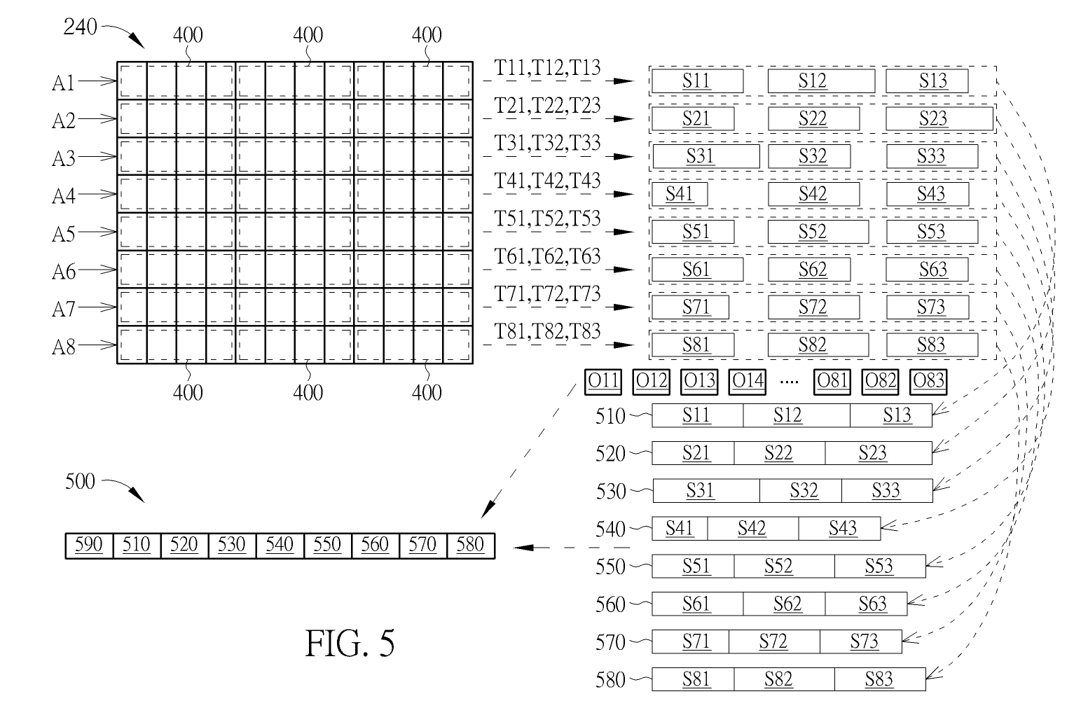

Please refer to FIG. 1 with reference to FIG. 3 and FIG. 5. FIG. 5 illustrates an overview of coding the quantized transform coefficients 240. In consideration of the characteristic of context adaptive variable length coding (CAVLC), all of the macroblocks 214 of any subgroup 300 are configured to be arranged in a corresponding one of rows R1 to R8, and all of the coefficient blocks 410 of any subgroup 400 are arranged in a corresponding one of rows A1 to A8 accordingly. When the entropy encoder 130 codes the quantized transform coefficients 240 and the prediction parameters 230 into encoded data of the encoded frame 212, the entropy encoder 130 simultaneously performs a plurality of CAVLC procedures T11 to T83 to code the quantized transform coefficients 240 into a plurality of coded strings S11 to S83. Each of the CAVLC procedures T11 to T83 is configured to code quantized transform coefficients of a corresponding subgroup 400 into one of the coded strings S11 to S83. For example, through the CAVLC procedures T11 to T13, the quantized transform coefficients of three subgroups 400 in the first row A1 are coded into three coded strings S11 to S13 respectively. Through the CAVLC procedures T21 to T23, the quantized transform coefficients of three subgroups 400 in the second row A2 are coded into three coded strings S21 to S23 respectively. The coded strings S31 to S83 corresponding to the third to eighth rows A3 to A8 are generated in a similar way. It should be noted that it is not necessary to perform all of the CAVLC procedures T11 to T83 at a time. In an embodiment of the present invention, the entropy encoder 130 of the video encoder 100 only simultaneously performs some of the CAVLC procedures T11 to T83 at one time. After the coded strings S11 to S83 are generated, the entropy encoder 130 outputs encoded data 500 of the encoded frame 212 according to the coded strings S11 to S83. Since some or all of the CAVLC procedures T11 to T83 are performed simultaneously, the efficiency of coding the quantized transform coefficients 240 is enhanced.

In an embodiment of the present invention, the entropy encoder 130 may merge the coded strings converted from the subgroups 400 in a same row into a piece of data. As shown in FIG. 5, the coded strings S11 to S13 converted from the subgroups 400 in the first row A1 are merged into a piece of data 510, the coded strings S21 to S23 converted from the subgroups 400 in the second row A2 are merged into a piece of data 520, the coded strings S31 to S33 converted from the subgroups 400 in the third row A3 are merged into a piece of data 530, the coded strings S41 to S43 converted from the subgroups 400 in the fourth row A4 are merged into a piece of data 540, the coded strings S51 to S53 converted from the subgroups 400 in the fifth row A5 are merged into a piece of data 550, the coded strings S61 to S63 converted from the subgroups 400 in the sixth row A6 are merged into a piece of data 560, the coded strings S71 to S73 converted from the subgroups 400 in the seventh row A7 are merged into a piece of data 570, and the coded strings S81 to S83 converted from the subgroups 400 in the eighth row A8 are merged into a piece of data 580. The entropy encoder 130 may merge the pieces of data 510 to 580 into the encoded data 500 of the encoded frame 212. In an embodiment of the present invention, the encoded data 500 may further comprise related information 590 about the encoded frame 212, and the related information 590 may include the prediction parameters 230 shown in FIG. 1.

In an embodiment of the present invention, when the coded strings S11 to S83 are merged into the encoded data 500, the entropy encoder 130 calculates an offset for each of the coded strings S11 to S83. As shown in FIG. 5, offsets O11 to O83 of the coded strings S11 to S83 are calculated. Each of the offsets O11 to O83 of a coded string is determined based on the lengths of preceding coded strings thereof. For example, the offset O81 of the coded string S81 is determined based on the lengths of coded strings S11 to S73, and the offset O11 is equal to zero since the coded string S11 is the first coded string. The offsets O11 to O83 may be recorded in the related information 590. Accordingly, a decoder could correctly extract the coded strings S11 to S83 from the encoded data 500 according to the recorded offsets O11 to O83 and reconstruct the encoded frame 212 according to the extracted coded strings S11 to S83.

In the foresaid embodiments, numbers of the macroblocks 214 of the subgroups 300 are identical. However, the subgroups 300 may have diverse numbers of the macroblocks 214 in other embodiments of the present invention. In the condition, the entropy encoder 130 generates a coded string for each subgroup 300 by performing a CAVLC procedure to code quantized transform coefficients of a subgroup 400 corresponded to the subgroup 300. Then, the entropy encoder 130 generates and outputs the encoded data 500 of the encoded frame 212 according to the coded strings.

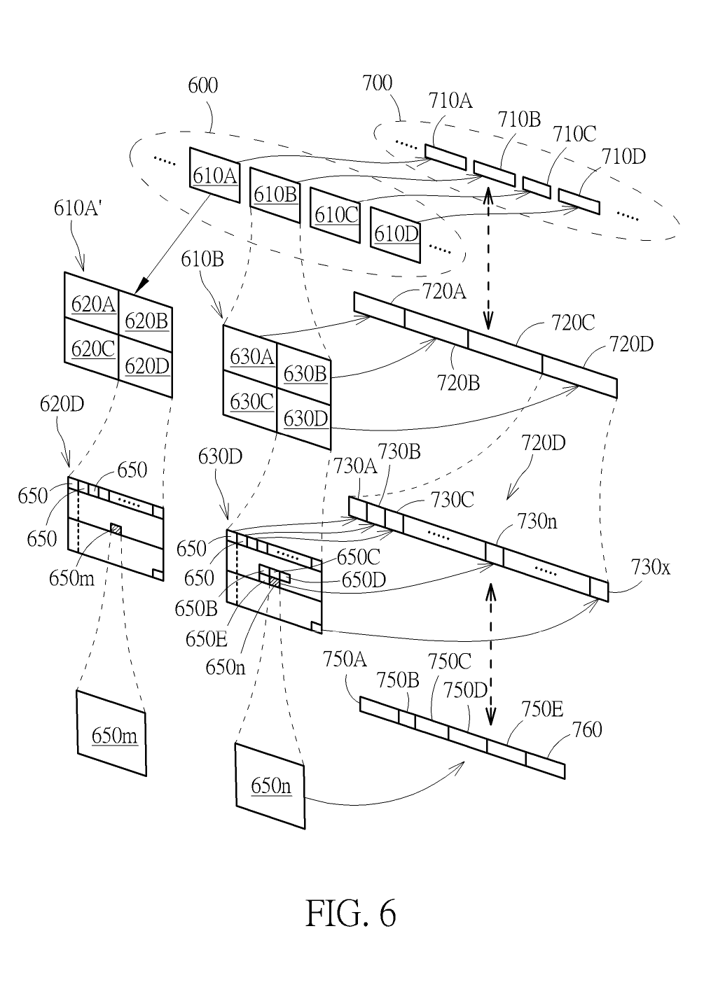

In an embodiment of the present invention, when the prediction model 110 predict the macroblocks of a frame, the frame is separated into a plurality of groups, and a plurality of prediction procedures are simultaneously performed to predict the macroblocks of the groups to generate a plurality of series of predictions. Each of the series of predictions are transformed into a set of quantized transform coefficients, and a plurality of CAVLC procedures are simultaneously performed to code the sets of the quantized transform coefficients into the encoded data of the encoded frame. Please refer to FIG. 6. FIG. 6 illustrates an overview of the structures of a video stream 600 and a bitstream 700. The video encoder 100 encodes the video stream 600 into the bitstream 700. The video stream 600 comprises a plurality of frames (e.g. frames 610A to 610D), and each of the frames of the video stream 600 contains a plurality of pixels for displaying an image. Each of the frames 610A to 610D is encoded into a corresponding one of encoded units 710A to 710D of the bitstream 700. The video encoder 100 may encode (or compress) the frames of the video stream 600 into a format that takes up less capacity when it is stored or transmitted. For example, a sequence of the video of the video stream 600 may be encoded into the H.264 format, and the bitstream 700 may be compatible with the H.264 syntax. In this case, the encoded units 710A to 710D of the bitstream 700 are network adaptation layer (NAL) units of the H.264 syntax.

As well as encoding the frame 610A as part of the bitstream 700, the video encoder 100 reconstructs the frame 610A, i.e. creates a copy of a decoded frame 610A′ according to relative encoded data of the frame 610A. This reconstructed copy may be stored in a coded picture buffer (CPB) and used during the encoding of further frames (e.g. the frame 610B). Accordingly, before the video encoder 100 encodes the frame 610B, the frame 610A may be encoded and reconstructed into the frame 610A′, such that the frame 610A′ would be used as a reference frame while encoding the frame 610B. Since the frame 610A is in a prior sequence than the frame 610B, the frame 610A′ is also in a prior sequence than the frame 610B.

The video encoder 100 uses the frame 610A′ to carry out prediction processes of the frame 610B to produce predictions of the frame 610B when encoding the frame 610B, such that the encoded unit 710B of the frame 610B may have a less data amount due to the predictions. During the prediction processes, the video encoder 100 processes the frame 610B in units of a macroblock (typically 16×16 pixels) and forms a prediction of the current macroblock based on previously-coded data, either from a previous frame (e.g. the frame 610A′) that have already been coded using inter prediction and/or from the current frame (e.g. the frame 610B) using intra prediction. The video encoder 100 accomplishes one of the prediction processes by subtracting the prediction from the current macroblock to form a residual macroblock.

The macroblocks 650 of the frames 610A′ and 610B are respectively separated into four groups 620A to 620D and 630A to 630D. The resolutions of the groups 620A to 620D and 630A to 630D are identical. Each of the groups 620A to 620D and 630A to 630D contains a plurality of macroblocks 650, and the macroblocks 650 of each group are arranged in m rows and n columns, where m and n are integers greater than 1. It should be noted that the number of the groups in each frame may be a number other than four, and the present invention is not limited thereto. For example, the number of the groups in each frame may be 2, 6, 8, 16, etc. For the sake of encoding efficiency of the video encoder 100, the number of the groups in each frame could be determined based on the architecture of the video encoder 100 and/or the resolution of the frames 610A′ and 610B. In addition, the integers m and n could be determined if the number of the groups of each frame 610A′ or 610B and the resolution of the frame 610A′ or 610B are known.

When the video encoder 100 encodes the image 610B, the groups 630A to 630D of the image 610B are simultaneously predicted by the video encoder 100. In other words, the video encoder 100 simultaneously performs a plurality of prediction procedures of the groups 630A to 630D to predict the macroblocks 650 of the groups 630A to 630D into a plurality of series of predictions 720A to 720D. In the embodiment, since the second frame has four groups 630A to 630D, the video encoder 100 simultaneously performs four prediction procedures to respectively predict the groups 630A, 630B, 630C and 630D into the series of predictions 720A, 720B, 720C and 720D. Therefore, the series of predictions 720A to 720D are generated synchronously. Due to parallel execution of a plurality of prediction procedures, the efficiency of the video encoder 100 for predicting macroblocks of frames is enhanced.

When one of the prediction procedures is performed to predict the macroblocks 650 of a target group of the groups 630A to 630D, the video encoder 100 successively performs a plurality of macroblock comparison procedures of the target group to generate a plurality of sub-strings of data and generates one of the series of predictions according to the sub-strings of data. For instance, when the video encoder 100 performs the prediction procedure to predict the group 630D, a plurality of macroblock comparison procedures of the group 630D are performed to generate a plurality of sub-strings of data 730A to 730x, and the series of predictions 720D would be generated according to the sub-strings of data 730A to 730x. Each of the sub-strings of data 730A to 730x is generated by performing one of the macroblock comparison procedures of a corresponding macroblock 650 of the group 630D. Take the sub-string of data 730n for example, the sub-string of data 730n is generated by performing the macroblock comparison procedure of the macroblock 650n.

Each of the macroblocks 650 of the frame 610B is associated with a macroblock set. The video encoder 100 forms a prediction of each macroblock 650 based on the macroblock set of the macroblock 650. For example, the macroblock set of the macroblock 650n comprises at least a reference macroblock 650m of a reference group 620D in the frame 610A′. The reference macroblock 650m and the target macroblock 650n have the same coordinates in the frames 610A′ and 610B. Therefore, the reference macroblock 650m may be used for inter prediction of the macroblock 650n. The macroblock set of the macroblock 650n may further comprise one or more macroblocks neighboring to the macroblock 650n in the group 630D. Therefore, one or more macroblocks belonged to the group 630D and neighboring to the macroblock 650n may be used for intra prediction of the macroblock 650n.

The number of the macroblocks of the macroblock set of each macroblock 650 could be determined based on the coordinates of the macroblock 650 in a corresponding group. The macroblock 650n in the group 630D will be taken for an example in the following descriptions. If the macroblock 650n is not in the first row, the first column or the last column of the group 630D, the macroblock set of the macroblock 650n further comprises a macroblock 650B at the upper left corner of the macroblock 650n, a macroblock 650C above the macroblock 650n, a macroblock 650D at the upper right corner of the macroblock 650n, and a macroblock 650E at a left side of the macroblock 650n. However, if the macroblock 650n is in the first row of the group 630D, the macroblock set of the macroblock 650n does not comprise the macroblocks 650B, 650C and 650D, but the macroblock set of the macroblock 650n comprises the macroblock 650E. If the macroblock 650n is in the first column of the group 630D, the macroblock set of the macroblock 650n does not comprise the macroblocks 650B and 650E, but the macroblock set of the macroblock 650n comprises the macroblocks 650C and 650D. If the macroblock 650n is in the last column of the group 630D, the macroblock set of the macroblock 650n does not comprise the macroblock 650D, but the macroblock set of the macroblock 650n comprises the macroblocks 650B, 650C and 650E. In other words, if the macroblock 650n is a macroblock other than the macroblock in the first row and the first column of the group 630D, the macroblock set of the macroblock 650n further comprises one or more macroblocks selected from macroblocks neighboring to the macroblock 650n in the group 630D. Since the macroblocks 650B, 650C, 650D and 650E are neighboring to the macroblock 650n, the macroblocks 650B, 650C, 650D and 650E could be used for the intra prediction of the macroblock 650n. In an embodiment of the present invention, the macroblocks 650B, 650C, 650D and 650E have been predicted while the video encoder 100 predicts the macroblock 650n.

Each of the macroblock comparison procedures of the frame 610B is configured to compare a target macroblock of the m×n macroblocks in a corresponding target group of the groups 630A to 630D of the frame 610B with each macroblock of the macroblock set of the target macroblock, and each of the macroblock comparison procedures is also configured to compare the target macroblock with at least one macroblock of the macroblock set of the target macroblock to generate at least one piece of relative data. In the embodiment, the macroblock set of the macroblock 650n comprises the macroblocks 650m, 650B, 650C, 650D and 650E. During the macroblock comparison procedure of the macroblock 650n, the macroblocks 650m, 650B, 650C, 650D and 650E are separately compared with the macroblock 650n to generate a plurality of pieces of relative data 750A, 750B, 750C, 750D and 750E respectively. The video encoder 100 uses the pieces of relative data 750A, 750B, 750C, 750D and 750E and data 760 of the macroblock 650n to predict the macroblock 650n. When the macroblock comparison procedure of the macroblock 650n is performed, the video encoder 100 selects a piece of data with a smallest number of bits from the data 760 of the macroblock 650n and the pieces of relative data 750A, 750B, 750C, 750D and 750E, and generates the sub-string of data 730n according to the selected piece of data with the smallest number of bits. Since the video encoder 100 generates the sub-string of data 730n according to the selected piece of data with the smallest number of bits, the sub-string of data 730n takes up less capacity.

In an embodiment of the present invention, the video encoder 100 is an H.264 video encoder for carrying out prediction, transform and coding processes to produce a compressed H.264 bitstream (i.e. syntax), and each of the macroblock comparison procedures is one of the prediction processes performed according to H.264 algorithm. During the prediction processes, the video encoder 100 processes the groups of each frame of the video stream 600 in units of a macroblock and forms a prediction of the current macroblock (e.g. the macroblock 650n) based on previously-coded data, either from the current frame (e.g. the frame 610B) using intra prediction or from a previous frame (e.g. the frame 610A′) that have already been coded using inter prediction.

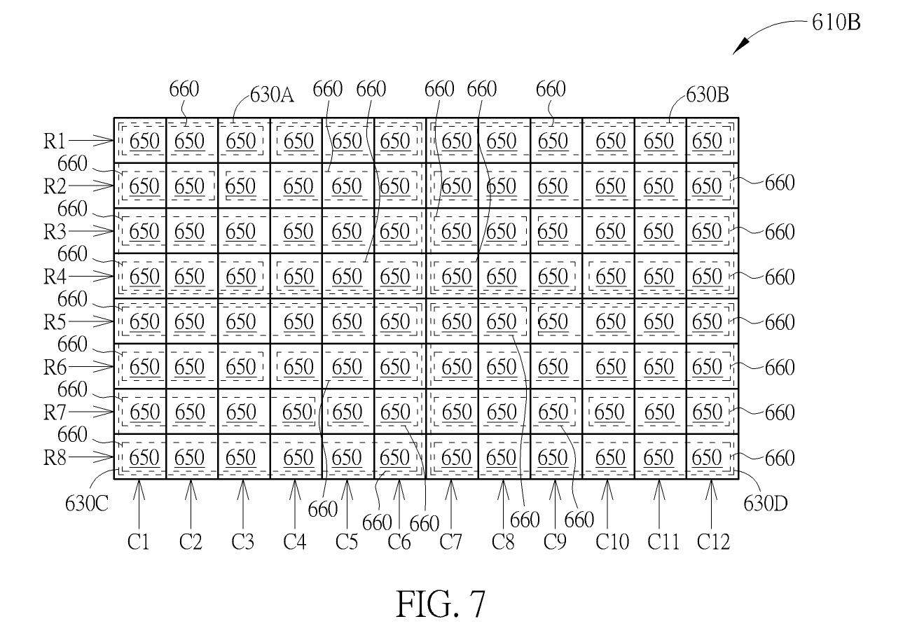

Please refer to FIG. 7. FIG. 7 is a schematic diagram of the frame 610B. The macroblocks 650 of the frame 610B are arranged in eight rows R1 to R8 and twelve columns C1 to C12, each of the groups 630A to 630D of the frame 610B comprises a plurality of subgroups 660, and each of the subgroup 660 comprises a plurality of the macroblocks 650. In the embodiment, the subgroups 660 of the frame 610B have diverse numbers of the macroblocks 650. However, the numbers of the macroblocks 650 of the subgroups 660 may be identical in another embodiment of the present invention.

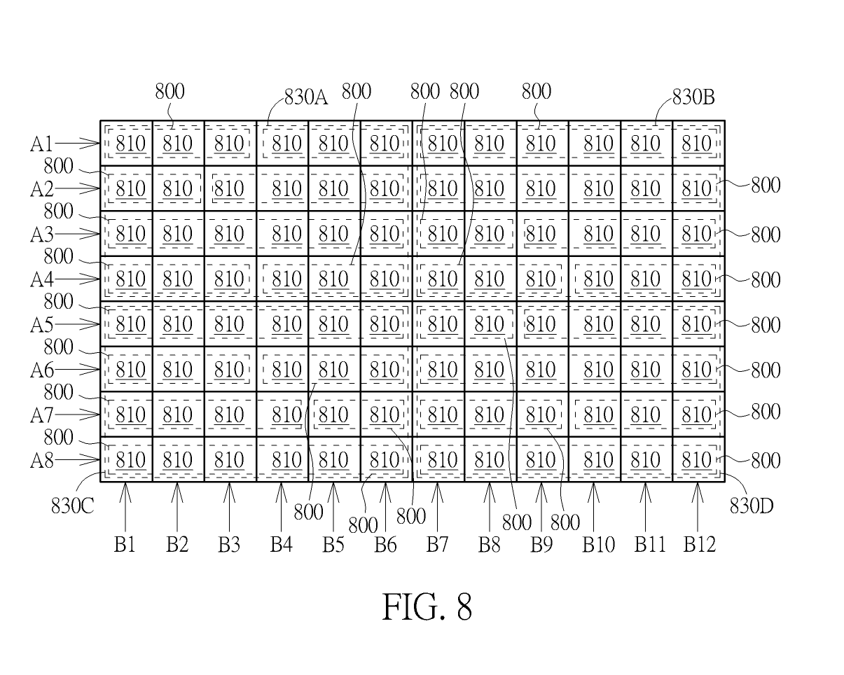

The series of predictions 720A to 720D are transformed into sets of quantized transform coefficients respectively. Please refer to FIG. 8. FIG. 8 is a schematic diagram of sets of quantized transform coefficients 830A to 830D transformed from the series of predictions 720A to 720D. Since the video encoder 100 predicts the groups 630A to 630D in units of a macroblock 650, and the sets of quantized transform coefficients 830A to 830D are transformed from the series of predictions 720A to 720D, the sets of quantized transform coefficients 830A to 830D could be represented based on the arrangement of the macroblocks 650 of the frame 610B. Accordingly, the sets of quantized transform coefficients 830A to 830D could be represented by a plurality of coefficient blocks 810 arranged in eight rows A1 to A8 and twelve columns B1 to B12. Each of the coefficient blocks 810 is corresponded to a macroblock 650 and arranged at a location related to the macroblock 650. For example, the coefficient block 810 in the first row A1 and the first column B1 is corresponded to the macroblock 650 in the first row R1 and the first column C1, the coefficient block 810 in the first row A1 and the second column B2 is corresponded to the macroblock 650 in the first row R1 and the second column C2, and so on. In addition, each of the coefficient blocks 810 comprises related quantized transform coefficients converted from the corresponded macroblock 650. For instance, the coefficient block 810 in the first row A1 and the first column B1 comprises the quantized transform coefficients converted from the macroblock 650 in the first row R1 and the first column C1, the coefficient block 810 in the first row A1 and the second column B2 comprises the quantized transform coefficients converted from the macroblock 650 in the first row R1 and the second column C2, and so on.

Moreover, each of the sets of the quantized transform coefficients 830A to 830D also could be represented by a plurality of subgroups 800, and each of the subgroups 800 is corresponded to a subgroup 660 of the frame 610B and comprises a plurality of the coefficient blocks 810.

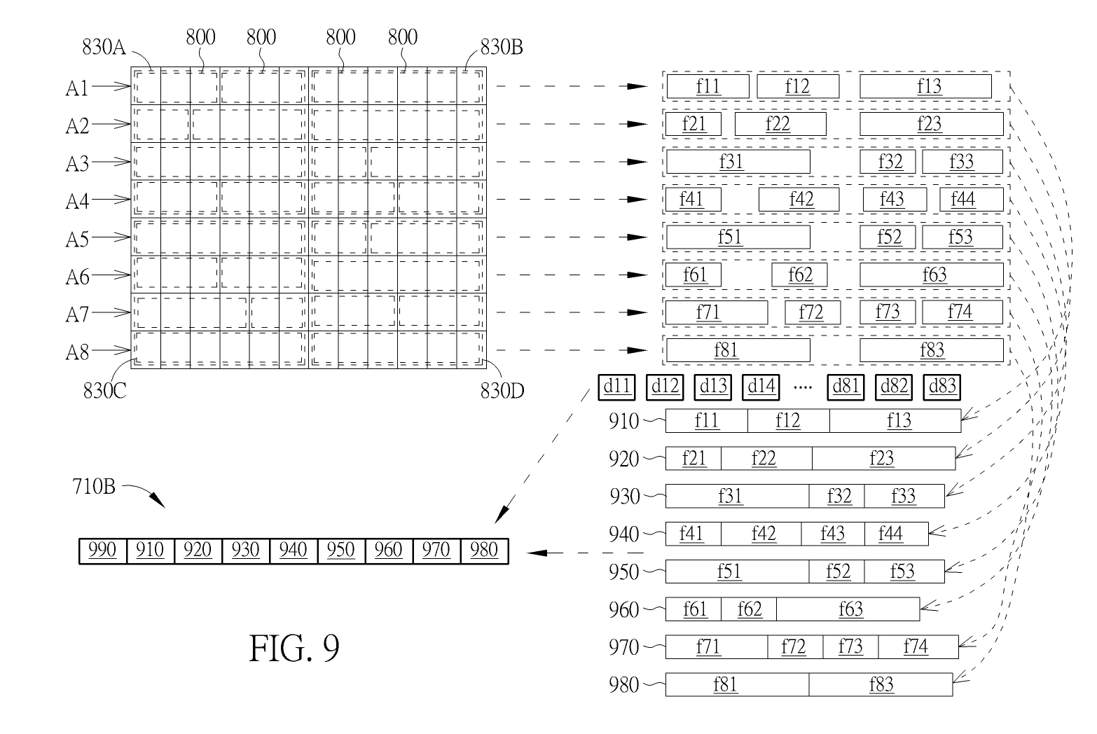

Please refer to FIG. 9. FIG. 9 illustrates an overview of coding the sets of the quantized transform coefficients 830A to 830D. In consideration of the characteristic of context adaptive variable length coding (CAVLC), all of the macroblocks 650 of any subgroup 660 are configured to be arranged in a corresponding one of rows R1 to R8, and all of the coefficient blocks 810 of any subgroup 800 are arranged in a corresponding one of rows A1 to A8 accordingly. When the entropy encoder 130 of the video encoder 100 codes the sets of the quantized transform coefficients 830A to 830D into encoded data (i.e. the coded unit 710B) of the encoded frame 610B, the entropy encoder 130 simultaneously performs a plurality of CAVLC procedures to code the sets of the quantized transform coefficients 830A to 830D into a plurality of coded strings f11 to f82. Each of the CAVLC procedures is configured to code quantized transform coefficients of a corresponding one of the subgroups 800 into one of the coded strings f11 to f82. It should be noted that it is not necessary to perform all of the CAVLC procedures at a time. In an embodiment of the present invention, the entropy encoder 130 of the video encoder 100 only simultaneously performs some of the CAVLC procedures at one time. After the coded strings f11 to f82 are generated, the entropy encoder 130 outputs encoded data 710B of the frame 610B according to the coded strings f11 to f82. Since some or all of the CAVLC procedures are performed simultaneously, the efficiency of coding the sets of the quantized transform coefficients 830A to 830D is enhanced.

In an embodiment of the present invention, the entropy encoder 130 may merge the coded strings converted from the subgroups 800 in a same row into a piece of data. As shown in FIG. 9, the coded strings f11 to f13 converted from the subgroups 800 in the first row A1 are merged into apiece of data 910, the coded strings f21 to f23 converted from the subgroups 800 in the second row A2 are merged into a piece of data 920, the coded strings f31 to f33 converted from the subgroups 800 in the third row A3 are merged into a piece of data 930, the coded strings f41 to f44 converted from the subgroups 800 in the fourth row A4 are merged into a piece of data 940, the coded strings f51 to f53 converted from the subgroups 800 in the fifth row A5 are merged into a piece of data 950, the coded strings f61 to f63 converted from the subgroups 800 in the sixth row A6 are merged into a piece of data 960, the coded strings f71 to f74 converted from the subgroups 800 in the seventh row A7 are merged into a piece of data 970, and the coded strings f81 to f82 converted from the subgroups 800 in the eighth row A8 are merged into a piece of data 980. The entropy encoder 130 may merge the pieces of data 910 to 980 into the encoded data 710B of the frame 610B. In an embodiment of the present invention, the encoded data 710B may further comprise related information 990 about the frame 710B, and the related information 990 may include the prediction parameters.

In an embodiment of the present invention, when the coded strings f11 to f82 are merged into the encoded data 710B, the entropy encoder 130 calculates an offset for each of the coded strings f11 to f82. As shown in FIG. 9, offsets d11 to d82 of the coded strings f11 to f82 are calculated. Each of the offsets d11 to d82 of a coded string is determined based on the lengths of preceding coded strings thereof. For example, the offset d81 of the coded string f81 is determined based on the lengths of coded strings f11 to f74, and the offset f11 is equal to zero since the coded string f11 is the first coded string. The offsets d11 to d82 may be recorded in the related information 990. Accordingly, a decoder could correctly extract the coded strings f11 to f82 from the encoded data 710B according to the recorded offsets d11 to d82 and reconstruct the frame 610B according to the extracted coded strings f11 to f82.

In summary, the present invention provides a method capable of simultaneously performing a plurality of CAVLC procedures to code the quantized transform coefficients of subgroups of a single frame into the encoded data. Therefore, the efficiency of encoding a video stream is enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for simultaneously coding quantized transform coefficients of subgroups of a target frame by an encoder, the target frame containing M×N macroblocks arranged in M rows and N columns, each of the subgroups containing a plurality of macroblocks of the M×N macroblocks, and the macroblocks of each subgroup being arranged in a corresponding one of the M rows, the method comprising:
simultaneously performing a plurality of context adaptive variable length coding (CAVLC) procedures of the target frame to generate a plurality of coded strings, wherein each of the CAVLC procedures is configured to code quantized transform coefficients of a subgroup of the target frame into a coded string; and
outputting encoded data of the target frame by the encoder according to the coded strings.

2. The method of claim 1 further comprising:
merging coded strings of subgroups in a same row into a piece of data; and
merging pieces of data into the encoded data of the target frame.

3. The method of claim 1 further comprising:
calculating an offset for each of the coded strings;
wherein the encoder generates the encoded data of the target frame according to the coded strings and the offsets of the coded strings.

4. The method of claim 1, wherein the subgroups of the target frame have diverse numbers of the macroblocks.

5. The method of claim 1, wherein numbers of the macroblocks of the subgroups are identical.

6. A method for simultaneously encoding macroblocks of one of frames of a video stream by an encoder, a reference frame associated with the frames of the video stream being in a prior sequence than a target frame of the video stream, each of the reference frame and the target frame comprising a plurality of groups, each of the groups containing m×n macroblocks arranged in m rows and n columns, m and n being integers greater than 1, each of the groups of the target frame comprising a plurality of subgroups, and each of the subgroups containing a plurality of macroblocks arranged in a corresponding one of the m rows of a group, the method comprising:
simultaneously performing a plurality of prediction procedures of the groups of the second frame to generate a plurality of series of predictions, wherein each of the prediction procedures is configured to predict macroblocks of a target group of the groups of the second frame and comprises:
performing a plurality of macroblock comparison procedures of the target group to generate a plurality of sub-strings of data, wherein each macroblock comparison procedure is configured to compare a target macroblock of the m×n macroblocks of the target group with each macroblock of a macroblock set associated with the target macroblock, and the macroblock set comprises a reference macroblock of a reference group of the first frame; and
generating one of the series of predictions according to the sub-strings of data;
transforming the series of predictions into quantized transform coefficients of the subgroups of the target frame;
simultaneously performing a plurality of context adaptive variable length coding (CAVLC) procedures of the target frame to generate a plurality of coded strings, wherein each of the CAVLC procedures is configured to code quantized transform coefficients of a subgroup of the target frame into a coded string; and
outputting encoded data of the target frame by the encoder according to the coded strings.

7. The method of claim 6 further comprising:
merging coded strings of subgroups in a same row into a piece of data; and
merging pieces of data into the encoded data of the target frame.

8. The method of claim 6 further comprising:
calculating an offset for each of the coded strings;
wherein the encoder generates the encoded data of the target frame according to the coded strings and the offsets of the coded strings.

9. The method of claim 6, wherein the subgroups of the target frame have diverse numbers of the macroblocks.

10. The method of claim 6, wherein numbers of the macroblocks of the subgroups are identical.
